(19) United States
(12) Patent Application Publication
(10) Pub. No.: US 2025/0180060 A1
(43) Pub. Date: Jun. 5, 2025

(54) FASTENER ASSEMBLY

(71) Applicant: Caterpillar Inc., Peoria, IL (US)

(72) Inventor: Travis Stephen Bengtson, Washington, IL (US)

(73) Assignee: Caterpillar Inc., Peoria, IL (US)

(21) Appl. No.: 18/524,406

(22) Filed: Nov. 30, 2023

(51) Int. Cl. F16B 39/26; F16B 39/02

(52) U.S. Cl. CPC F16B 39/26; F16B 39/025; F16B 2200/99

(57) ABSTRACT

A fastener assembly includes a fastening element. The fastening element includes a head portion and a shank portion fixedly coupled to the head portion. The fastener assembly also includes a clip removably coupled to the fastening element. The clip includes an annular, base portion and a pair of first retention elements, at least a portion of the first retention elements is disposed oblique to diametrically opposing ends of the base portion. The clip defines a receiving space. The fastener assembly further includes at least one conical spring washer received within the receiving space of the clip. The at least one conical spring washer is disposed between the base portion of the clip and the head portion of the fastening element.

### TECHNICAL FIELD

The present disclosure relates to a fastener assembly and a method of assembling the fastener assembly.

### BACKGROUND

A fastener is typically used to removably couple two components. The fastener may include a bolt, a screw, a pin, and the like to removably couple the two components. Generally, one or more washers are used in conjunction with the fastener to provide a broader bearing surface for a head of the fastener. The washers may also prevent loosening of the fastener, for example, due to rotation of the fastener, vibrations, or thermal expansion. The washers may include, for example, conical spring washers and/or flat washers. Typically, the fasteners and the washers are manually assembled. In some examples, the washers may be incorrectly assembled, which may render the washers ineffective. For example, an order of assembly of the washers may be inaccurate or the washers may not be positioned in a correct orientation. Further, it may be time-consuming and inefficient to observe the washers to determine a correct direction and orientation of the washers during assembly.

In some cases, a mechanical/electrical joint may require a stack of conical spring washers as well as flat washers. However, an assembly personnel may assemble the flat washer and the conical spring washers in an incorrect order or may install an incorrect quantity of flat washers and the conical spring washers, which may compromise a quality of the mechanical/electrical joint. Furthermore, simultaneously assembling of two or more loose hardware components, such as multiple conical spring washers and multiple flat washers, may be time consuming, may be tedious, and may be prone to errors.

Overall, current techniques of assembling fasteners with washers may be time consuming, may be prone to errors, and may cause failures due to incorrect assembling at the point of use.

Further, some conventional fasteners include push-on washers/clips that engage with threads of the fastener. However, such push-on washers/clips do not allow for axial movement of the fastener relative to a clamping surface, which is a requirement for conical spring washer usage. Additionally, some push-on washers/clips include tabs that extend below the clamping surface which may interfere with the part being clamped. In order to address the issue of the tabs interfering with the part being clamped, such push-on washers/clips require a slot or undercut in the fastener to latch into, which may reduce a strength of the fastener. Moreover, some washers are coupled to the fastener using adhesives. However, adhesives may increase debris in the joint and may are not reusable, upon dis-assembly.

U.S. Pat. No. 7,674,080 discloses a retaining washer for retaining threaded fasteners, such as bolts, that have been inadvertently loosened, in use. The invention finds particular application in gas turbine engines and in aircraft in general where wire locking of threaded fasteners has traditionally been employed. The washer comprises a base member having a plurality of apertures each for receiving the shank of a respective bolt or stud part of a threaded fastener, and engagement means extending from the base member for engagement with respective bolt head or nut parts of the fasteners to retain the said head or nut parts with respect to the washer in the event of inadvertent loosening. The said engagement means is deformable between an open configuration which enables access to the bolt head or nut parts of the fasteners for tightening and/or removal thereof and a closed configuration in which the bolt head or nut part are captively retained with the washer.

### SUMMARY OF THE DISCLOSURE

In an aspect of the present disclosure, a fastener assembly is provided. The fastener assembly includes a fastening element. The fastening element includes a head portion and a shank portion fixedly coupled to the head portion. The fastener assembly also includes a retention system coupled to the fastening element. The retention system includes a clip removably coupled to the fastening element. The clip includes an annular, base portion. The clip also includes a pair of first retention elements, at least a portion of the first retention elements is disposed oblique to diametrically opposing ends of the base portion. The clip defines a receiving space. The retention system also includes at least one conical spring washer received within the receiving space of the clip. The at least one conical spring washer is disposed between the base portion of the clip and the head portion of the fastening element.

In another aspect of the present disclosure, a method of assembling a fastener assembly is provided. The method includes providing a clip of the fastener assembly. The clip includes an annular, base portion and a pair of first retention elements, at least a portion of the first retention elements is disposed oblique to diametrically opposing ends of the base portion. The clip defines a receiving space. The method also includes removably coupling at least one conical spring washer of the fastener assembly with the clip. The at least one conical spring washer is received within the receiving space of the clip. The method further includes providing a fastening element of the fastener assembly. The fastening element includes a head portion and a shank portion fixedly coupled to the head portion. The method includes removably coupling the clip and the at least one conical spring washer with the fastening element. The at least one conical spring washer is disposed between the base portion of the clip and the head portion of the fastening element.

Other features and aspects of this disclosure will be apparent from the following description and the accompanying drawings.

### BRIEF DESCRIPTION OF THE DRAWINGS

FIG. 1 is a schematic perspective view of a fastener assembly, according to an example of the present disclosure;

FIG. 2 is a schematic perspective view of a fastener assembly, according to another example of the present disclosure;

FIG. 3 is a schematic perspective view of a retention system of the fastener assembly of FIG. 2;

FIG. 4 is a schematic perspective view of a fastener assembly, according to yet another example of the present disclosure;

FIG. 5 is a schematic perspective view of a fastener assembly, according to yet another example of the present disclosure;

FIG. 6 is a schematic perspective view of a fastener assembly, according to yet another example of the present disclosure;

FIG. 7 is a schematic side view of a pair of conical spring washers of the fastener assembly of FIG. 6 arranged in a parallel arrangement;

FIG. 8 is a schematic side view of a pair of conical spring washers arranged in a series arrangement, according to yet another example of the present disclosure;

FIG. 9 is a schematic side view of a number of conical spring washers arranged in a series-parallel arrangement, according to yet another example of the present disclosure; and

FIG. 10 is a flowchart for a method of assembling the fastener assembly of FIGS. 2 to 9, according to an example of the present disclosure.

### DETAILED DESCRIPTION

Wherever possible, the same reference numbers will be used throughout the drawings to refer to the same or like parts.

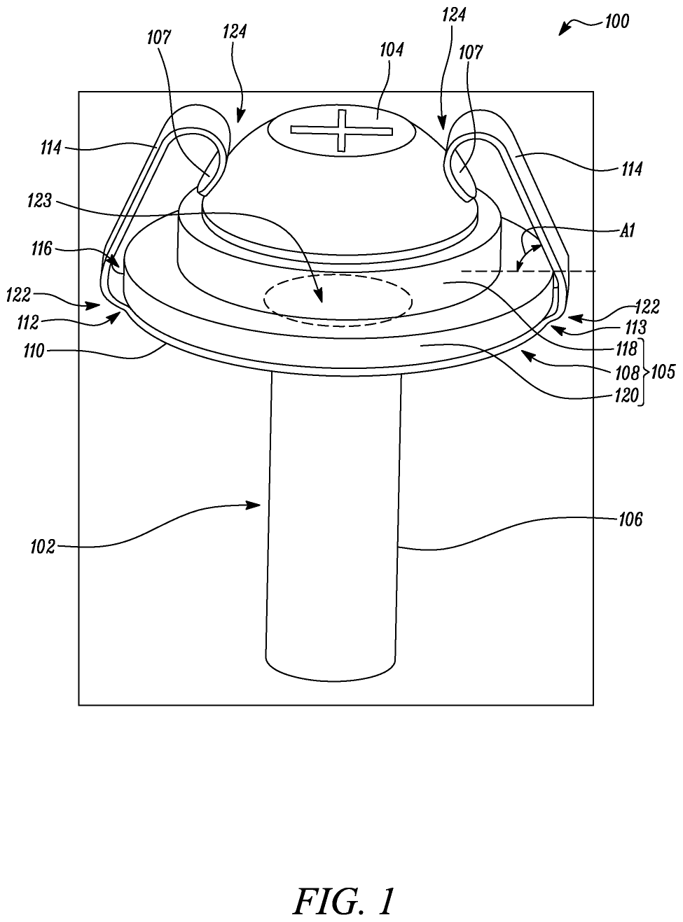

Referring to FIG. 1, a schematic perspective view of a fastener assembly 100 is illustrated. The fastener assembly 100 may be used to join two or more components. In an example, the fastener assembly 100 may be used to join two components, in order to establish electric connectivity therebetween. In some examples, the fastener assembly 100 may be used in energy storage systems or drive systems for work/construction machines. The fastener assembly 100 may be associated with cabinets, inverters, enclosures, and the like. In an example, the fastener assembly 100 may be used to connect a busbar with a terminal assembly, without any limitations.

The fastener assembly 100 includes a fastening element 102. The fastening element 102 is embodied as a bolt herein. The fastening element 102 includes a head portion 104. In some examples, the head portion 104 may have a circular head, a hexagonal head, and the like. In the illustrated example of FIG. 1, the head portion 104 has a circular head. The fastening element 102 also includes a shank portion 106 fixedly coupled to the head portion 104. In some examples, the shank portion 106 may include a number of threads (not shown) extending at least partially along a length of the shank portion 106.

The fastener assembly 100 also includes a retention system 105. The retention system 105 includes a clip 108 removably coupled to the fastening element 102. The clip 108 includes an annular, base portion 110. The base portion 110 defines a central opening 123. The central opening 123 at least partially receives the shank portion 106 of the fastening element 102.

The clip 108 also includes a pair of first retention elements 114. At least a portion of the pair of first retention elements 114 is disposed oblique to diametrically opposing ends 112, 113 of the base portion 110. Specifically, some portion of each first retention element 114 extends at an oblique angle A1 relative to the base portion 110. The clip 108 defines a receiving space 116. Each of the pair of first retention elements 114 of the clip 108 engages with the head portion 104 of the fastening element 102. Specifically, the engagement of the clip 108 with the head portion 104 may allow removable coupling of the clip 108 with the fastening element 102. Each of the pair of first retention elements 114 includes a first end 122 fixedly coupled to the base portion 110 and a second end 124 removably coupled to the head portion 104 of the fastening element 102. Further, each of the pair of first retention elements 114 may include a curved profile and/or a planar profile at the second end 124 thereof. In the illustrated example of FIG. 1, the second end 124 of each of the pair of first retention elements 114 includes the curved profile. Specifically, each first retention element 114 includes a curved portion 107 at the second end 124 that engages with the head portion 104 of the fastening element 102. In some examples, the clip 108 may be made of a metallic material, such as, steel. Alternatively, the clip 108 may be made of any other material, without limiting the scope of the present disclosure.

The retention system 105 also includes one or more conical spring washers 118 received within the receiving space 116 of the clip 108. In the illustrated example of FIG. 1, the retention system 105 includes a single conical spring washer 118 received within the receiving space 116 of the clip 108. However, the fastener assembly 100 may include two or more conical spring washers 118 based on application attributes. The conical spring washer 118 is disposed between the base portion 110 of the clip 108 and the head portion 104 of the fastening element 102. It should be noted that the conical spring washer 118 defines an opening (not shown) that aligns with the central opening 123 of the clip 108 to at least partially receive the shank portion 106 of the fastening element 102 therein.

The retention system 105 further includes one or more flat washers 120 received within the receiving space 116 of the clip 108. In the illustrated example of FIG. 1, the retention system 105 includes a single flat washer 120. In other examples, the retention system 105 may include two or more flat washers 120 based on application attributes. The flat washer 120 is disposed between the base portion 110 of the clip 108 and the conical spring washer 118. It should be noted that the flat washer 120 defines an opening (not shown) that aligns with the central opening 123 of the clip 108 and the opening of the conical spring washer 118 to at least partially receive the shank portion 106 of the fastening element 102 therein.

Further, each of the pair of first retention elements 114 applies a retention force on the head portion 104 of the fastening element 102 to retain the flat washer 120 and the conical spring washer 118 between the base portion 110 of the clip 108 and the head portion 104 of the fastening element 102. Particularly, the curved portion 107 of each of the first retention element 114 applies the retention force on the head portion 104 of the fastening element 102 to retain the flat washer 120 and the conical spring washer 118 between the base portion 110 of the clip 108 and the head portion 104 of the fastening element 102.

In order to assemble the fastener assembly 100, the flat washer 120 and the conical spring washer 118 are coupled with the clip 108. Further, the shank portion 106 of the fastening element 102 is received within each of the central opening 123 of the clip 108, the opening of the flat washer 120, and the opening of the conical spring washer 118. The clip 108 is then pushed towards the head portion 104 of the fastening element 102, thereby engaging each of the pair of first retention elements 114 with the head portion 104 of the fastening element 102 via a snap arrangement.

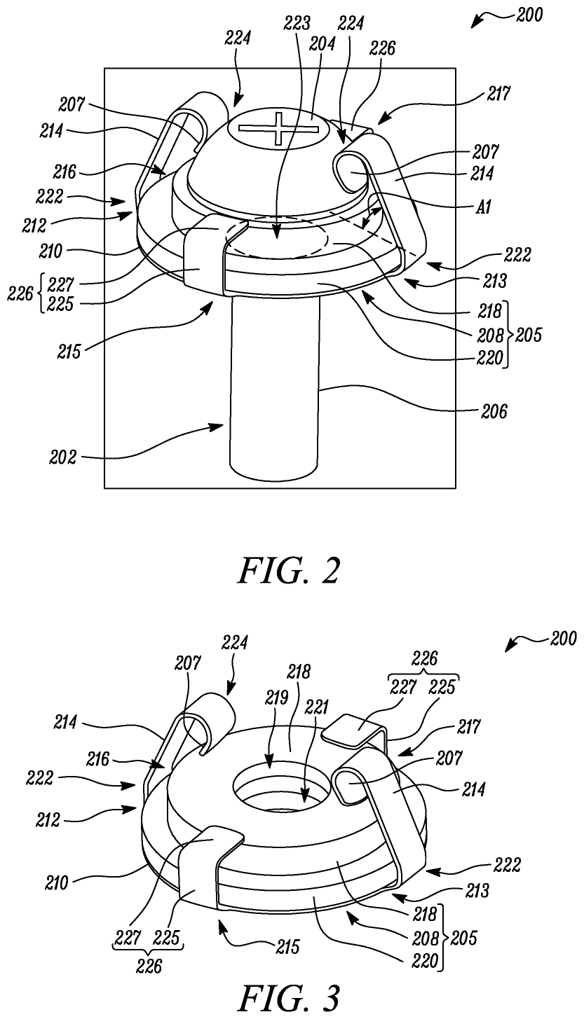

Referring to FIG. 2, a schematic perspective view of a fastener assembly 200 is illustrated, according to another example of the present disclosure. The fastener assembly 200 may be substantially similar to the fastener assembly 100 of FIG. 1. The fastener assembly 200 includes a fastening element 202. The fastening element 202 is embodied as a bolt herein. The fastening element 202 includes a head portion 204. In some examples, the head portion 204 may have a circular head, a hexagonal head, and the like. In the illustrated example of FIG. 2, the head portion 204 has a circular head. The fastening element 202 also includes a shank portion 206 fixedly coupled to the head portion 204. In some examples, the shank portion 206 may include a number of threads (not shown) extending at least partially along a length of the shank portion 206.

The fastener assembly 200 also includes a retention system 205. The retention system 205 includes a clip 208 removably coupled to the fastening element 202. The clip 208 includes an annular, base portion 210. The base portion 210 defines a central opening 223. The central opening 223 at least partially receives the shank portion 206 of the fastening element 202.

The clip 208 also includes a pair of first retention elements 214. At least a portion of the pair of first retention elements 214 is disposed oblique to diametrically opposing ends 212, 213 of the base portion 210. Specifically, some portion of each first retention element 214 extends at an oblique angle A1 relative to the base portion 210. The clip 208 defines a receiving space 216. Each of the pair of first retention elements 214 of the clip 208 engages with the head portion 204 of the fastening element 202. Specifically, the engagement of the clip 208 with the head portion 204 may allow removable coupling of the clip 208 with the fastening element 202. Each of the pair of first retention elements 214 includes a first end 222 fixedly coupled to the base portion 210 and a second end 224 removably coupled to the head portion 204 of the fastening element 202. Further, each of the pair of first retention elements 214 may include a curved profile and/or a planar profile at the second end 224 thereof. In the illustrated example of FIG. 2, the second end 224 of each of the pair of first retention elements 214 includes the curved profile. Specifically, each first retention element 214 includes a curved portion 207 at the second end 224 that engages with the head portion 204 of the fastening element 202. In some examples, the clip 208 may be made of a metallic material, such as, steel. Alternatively, the clip 208 may be made of any other material, without limiting the scope of the present disclosure.

The clip 208 also includes a pair of second retention elements 226 extending orthogonally from diametrically opposing ends 215, 217 of the base portion 210. Each of the pair of second retention elements 226 includes an L-shaped design herein. Specifically, each second retention element 226 includes a first member 225 extending orthogonally from the base portion 210. Each second retention element 226 also includes a second member 227 coupled to the first member 225 and extending orthogonally from the first member 225.

Referring to FIG. 3, a schematic perspective view of a portion of the fastener assembly 200 of FIG. 2 is illustrated. The retention system 205 further includes one or more conical spring washers 218 received within the receiving space 216 of the clip 208. In the illustrated example of FIG. 3, the retention system 205 includes a single conical spring washer 218 received within the receiving space 216 of the clip 208. However, the retention system 205 may include two or more conical spring washers 218 based on application attributes. The conical spring washer 218 is disposed between the base portion 210 of the clip 208 and the head portion 204 of the fastening element 202. It should be noted that the conical spring washer 218 defines an opening 219 that aligns with the central opening 223 (see FIG. 2) of the clip 208 to at least partially receive the shank portion 206 of the fastening element 202 therein.

The retention system 205 further includes one or more flat washers 220 received within the receiving space 216 of the clip 208. In the illustrated example of FIG. 3, the retention system 205 includes a single flat washer 220. In other examples, the retention system 205 may include two or more flat washers 220 based on application attributes. The flat washer 220 is disposed between the base portion 210 of the clip 208 and the conical spring washer 218. It should be noted that the flat washer 220 defines an opening 221 that aligns with the central opening 223 of the clip 208 and the opening 219 of the conical spring washer 218 to at least partially receive the shank portion 206 of the fastening element 202 therein.

With reference to FIGS. 2 and 3, each of the pair of first retention elements 214 applies a retention force on the head portion 204 of the fastening element 202 to retain the flat washer 220 and the conical spring washer 218 between the base portion 210 of the clip 208 and the head portion 204 of the fastening element 202. Particularly, the curved portion 207 of each first retention element 214 applies the retention force on the head portion 204 of the fastening element 202 to retain the flat washer 220 and the conical spring washer 218 between the base portion 210 of the clip 208 and the head portion 204 of the fastening element 202.

Furthermore, the second retention elements 226 retain the conical spring washer 218 within the receiving space 216 of the clip 208. The second retention elements 226 also retain the flat washer 220 within the receiving space 216 of the clip 208. It should be noted that, during assembly, the second retention elements 226 are bent over the conical spring washer 218, thereby plastically deforming the second retention elements 226 so that they do not return to their previous position. Further, in some examples, the second retention elements 226 may not directly contact the conical spring washer 218. However, the second retention elements 226 may prevent removal of the conical spring washer 218 and the flat washer 220 from the clip 208.

In order to assemble the fastener assembly 200, the flat washer 220 and the conical spring washer 218 are coupled with the clip 208, such that the flat washer 220 and the conical spring washer 218 are retained within the clip 208 by each second retention element 226. Further, the shank portion 206 of the fastening element 202 is received within each of the central opening 223 of the clip 208, the opening 221 of the flat washer 220, and the opening 219 of the conical spring washer 218. The clip 208 is then pushed towards the head portion 204 of the fastening element 202, thereby engaging each of the pair of first retention elements 214 with the head portion 204 of the fastening element 202 via a snap arrangement.

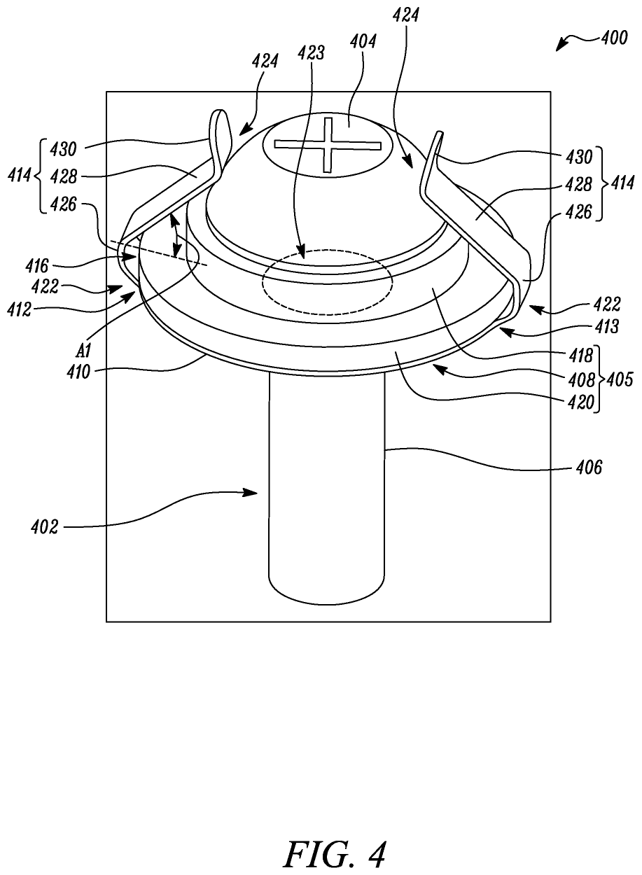

Referring to FIG. 4, a schematic perspective view of a fastener assembly 400 is illustrated, according to yet another example of the present disclosure. The fastener assembly 400 is substantially similar to the fastener assembly 100 of FIG. 1. The fastener assembly 400 includes a fastening element 402. The fastening element 402 is embodied as a bolt herein. The fastening element 402 includes a head portion 404. In some examples, the head portion 404 may have a circular head, a hexagonal head, and the like. In the illustrated example of FIG. 4, the head portion 404 has a circular head. The fastening element 402 also includes a shank portion 406 fixedly coupled to the head portion 404. In some examples, the shank portion 406 may include a number of threads (not shown) extending at least partially along a length of the shank portion 406.

The fastener assembly 400 also includes a retention system 405. The retention system 405 includes a clip 408 removably coupled to the fastening element 402. The clip 408 includes an annular, base portion 410. The base portion 410 defines a central opening 423. The central opening 423 at least partially receives the shank portion 406 of the fastening element 402.

The clip 408 also includes a pair of first retention elements 414. At least a portion of the pair of first retention elements 414 is disposed oblique to diametrically opposing ends 412, 413 of the base portion 410. The clip 408 defines a receiving space 416. Each of the pair of first retention elements 414 of the clip 408 engages with the head portion 404 of the fastening element 402. Specifically, the engagement of the clip 408 with the head portion 404 may allow removable coupling of the clip 408 with the fastening element 402. Each of the pair of first retention elements 414 includes a first end 422 fixedly coupled to the base portion 410 and a second end 424 removably coupled to the head portion 404 of the fastening element 402.

Further, each of the pair of first retention elements 414 may include a curved profile and/or a planar profile at the second end 424 thereof. In the illustrated example of FIG. 4, the second end 424 of each first retention element 414 includes the planar profile. Specifically, each first retention element 414 includes a first portion 426 extending orthogonally from the base portion 410, a second portion 428 extending obliquely relative to the base portion 410, and a third portion 430. The third portion 430 is substantially parallel to the first portion 426. The second portion 428 of each first retention element 414 extends at an oblique angle A1 relative to the base portion 410. The first portion 426 defines the first end 422 of the first retention element 414 and the third portion 430 defines the second end 424 of the first retention element 414. In some examples, the clip 408 may be made of a metallic material, such as, steel. Alternatively, the clip 408 may be made of any other material, without limiting the scope of the present disclosure.

The retention system 405 further includes one or more conical spring washers 418 received within the receiving space 416 of the clip 408. In the illustrated example of FIG. 4, the fastener assembly 400 includes a single conical spring washer 418 received within the receiving space 416 of the clip 408. However, the fastener assembly 400 may include two or more conical spring washers 418 based on application attributes. The conical spring washer 418 is disposed between the base portion 410 of the clip 408 and the head portion 404 of the fastening element 402. It should be noted that the conical spring washer 418 defines an opening (not shown) that aligns with the central opening 423 of the clip 408 to at least partially receive the shank portion 406 of the fastening element 402 therein.

The retention system 405 further includes one or more flat washers 420 received within the receiving space 416 of the clip 408. In the illustrated example of FIG. 4, the fastener assembly 400 includes a single flat washer 420. In other examples, the fastener assembly 400 may include two or more flat washers 420 based on application attributes. The flat washer 420 is disposed between the base portion 410 of the clip 408 and the conical spring washer 418. It should be noted that the flat washer 420 defines an opening (not shown) that aligns with the central opening 423 of the clip 408 and the opening of the conical spring washer 418 to at least partially receive the shank portion 406 of the fastening element 402 therein.

Further, each of the pair of first retention elements 414 applies a retention force on the head portion 404 of the fastening element 402 to retain the flat washer 420 and the conical spring washer 418 between the base portion 410 of the clip 408 and the head portion 404 of the fastening element 402.

In order to assemble the fastener assembly 400, the flat washer 420 and the conical spring washer 418 are coupled with the clip 408. Further, the shank portion 406 of the fastening element 402 is received within each of the central opening 423 of the clip 408, the opening of the flat washer 420, and the opening of the conical spring washer 418. The clip 408 is then pushed towards the head portion 404 of the fastening element 402, thereby engaging each of the pair of first retention elements 414 with the head portion 404 of the fastening element 402 via a snap arrangement.

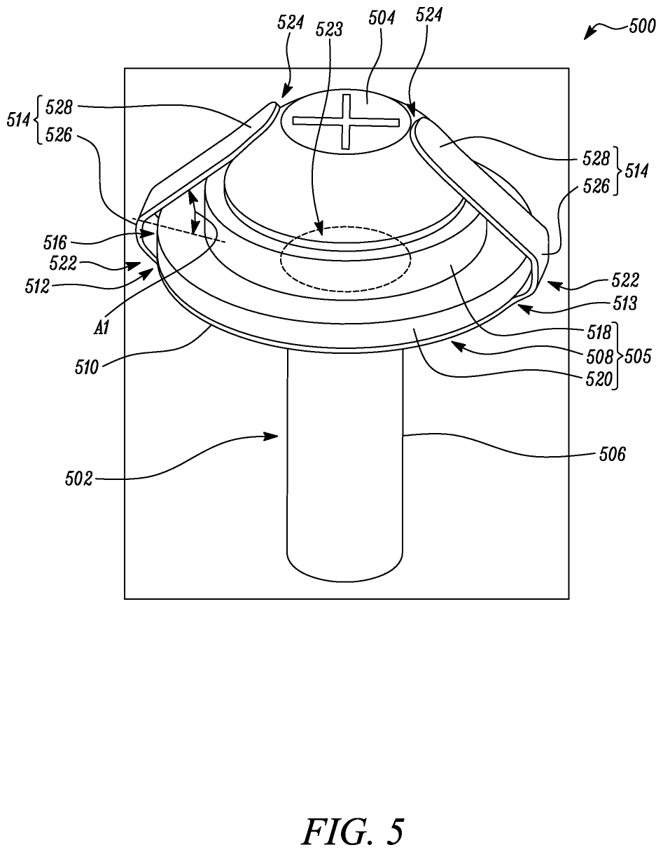

Referring to FIG. 5, a schematic perspective view of a fastener assembly 500 is illustrated, according to yet another example of the present disclosure. The fastener assembly 500 is substantially similar to the fastener assembly 100 of FIG. 1. The fastener assembly 500 includes a fastening element 502. The fastening element 502 is embodied as a bolt herein. The fastening element 502 includes a head portion 504. In some examples, the head portion 504 may have a circular head, a hexagonal head, and the like. In the illustrated example of FIG. 5, the head portion 504 has a circular head. The fastening element 502 also includes a shank portion 506 fixedly coupled to the head portion 504. In some examples, the shank portion 506 may include a number of threads (not shown) extending at least partially along a length of the shank portion 506.

The fastener assembly 500 also includes a retention system 505. The retention system 505 includes a clip 508 removably coupled to the fastening element 502. The clip 508 includes an annular, base portion 510. The base portion 510 defines a central opening 523. The central opening 523 at least partially receives the shank portion 506 of the fastening element 502.

The clip 508 also includes a pair of first retention elements 514. At least a portion of the pair of first retention elements 514 is disposed oblique to diametrically opposing ends 512, 513 of the base portion 510. The clip 508 defines a receiving space 516. Each of the pair of first retention elements 514 of the clip 508 engages with the head portion 504 of the fastening element 502. Specifically, the engagement of the clip 508 with the head portion 504 may allow removable coupling of the clip 508 with the fastening element 502. Each of the pair of first retention elements 514 includes a first end 522 fixedly coupled to the base portion 510 and a second end 524 removably coupled to the head portion 504 of the fastening element 502. Further, each of the pair of first retention elements 514 may include a curved profile and/or a planar profile at the second end 524 thereof. In the illustrated example of FIG. 5, the second end 524 of each of the pair of first retention elements 514 includes the planar profile. Specifically, each first retention element 514 includes a first portion 526 extending orthogonally from the base portion 510 and a second portion 528 extending obliquely relative to the base portion 510. The second portion 528 of each first retention element 514 extends at an oblique angle A1 relative to the base portion 510. The first portion 526 defines the first end 522 of the first retention element 514 and the second portion 528 defines the second end 524 of the first retention element 514. In some examples, the clip 508 may be made of a metallic material, such as, steel. Alternatively, the clip 508 may be made of any other material, without limiting the scope of the present disclosure.

The retention system 505 further includes one or more conical spring washers 518 received within the receiving space 516 of the clip 508. In the illustrated example of FIG. 5, the fastener assembly 500 includes a single conical spring washer 518 received within the receiving space 516 of the clip 508. However, the fastener assembly 500 may include two or more conical spring washers 518 based on application attributes. The conical spring washer 518 is disposed between the base portion 510 of the clip 508 and the head portion 504 of the fastening element 502. It should be noted that the conical spring washer 518 defines an opening (not shown) that aligns with the central opening 523 of the clip 508 to at least partially receive the shank portion 506 of the fastening element 502 therein.

The retention system 505 further includes one or more flat washers 520 received within the receiving space 516 of the clip 508. In the illustrated example of FIG. 5, the fastener assembly 500 includes a single flat washer 520. In other examples, the fastener assembly 500 may include two or more flat washers 520 based on application attributes. The flat washer 520 is disposed between the base portion 510 of the clip 508 and the conical spring washer 518. It should be noted that the flat washer 520 defines an opening (not shown) that aligns with the central opening 523 of the clip 508 and the opening of the conical spring washer 518 to at least partially receive the shank portion 506 of the fastening element 502 therein.

Further, each of the pair of first retention elements 514 applies a retention force on the head portion 504 of the fastening element 502 to retain the flat washer 520 and the conical spring washer 518 between the base portion 510 of the clip 508 and the head portion 504 of the fastening element 502.

In order to assemble the fastener assembly 500, the flat washer 520 and the conical spring washer 518 are coupled with the clip 508. Further, the shank portion 506 of the fastening element 502 is received within each of the central opening 523 of the clip 508, the opening of the flat washer 520, and the opening of the conical spring washer 518. The clip 508 is then pushed towards the head portion 504 of the fastening element 502. Further, a bending force is applied on each of the pair of first retention elements 514 until each of the pair of first retention elements 514 of the clip 508 engages with the head portion 504 of the fastening element 502, thereby engaging each of the pair of first retention elements 514 with the head portion 504 of the fastening element 502. In other words, the clip 508 is pushed towards the head portion 504 and the bending force is applied on the second portion 528 of each of the first retention element 514, thereby engaging the first retention elements 514 with the head portion 504 of the fastening element 502. Further, when the bending force is applied on the first retention elements 514, the first retention elements 514 plastically deform so that they do not return to their initial position.

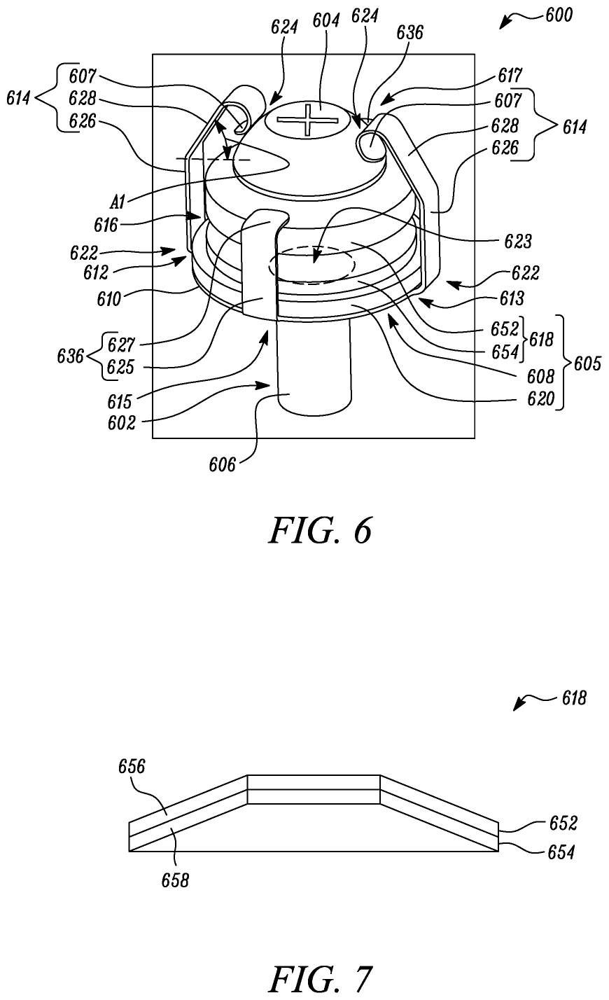

Referring to FIG. 6, a schematic perspective view of a fastener assembly 600 is illustrated, according to yet another example of the present disclosure. The fastener assembly 600 is substantially similar to the fastener assembly 200 of FIG. 2. The fastener assembly 600 includes a fastening element 602. The fastening element 602 is embodied as a bolt herein. The fastening element 602 includes a head portion 604. In some examples, the head portion 604 may have a circular head, a hexagonal head, and the like. In the illustrated example of FIG. 6, the head portion 604 has a circular head. The fastening element 602 also includes a shank portion 606 fixedly coupled to the head portion 604. In some examples, the shank portion 606 may include a number of threads (not shown) extending at least partially along a length of the shank portion 606.

The fastener assembly 600 also includes a retention system 605. The retention system 605 includes a clip 608 removably coupled to the fastening element 602. The clip 608 includes an annular, base portion 610. The base portion 610 defines a central opening 623. The central opening 623 at least partially receives the shank portion 606 of the fastening element 602.

The clip 608 also includes a pair of first retention elements 614. At least a portion of the pair of first retention elements 614 is disposed oblique to diametrically opposing ends 612, 613 of the base portion 610. The clip 608 defines a receiving space 616. Each of the pair of first retention elements 614 of the clip 608 engages with the head portion 604 of the fastening element 602. Specifically, the engagement of the clip 608 with the head portion 604 may allow removable coupling of the clip 608 with the fastening element 602.

Each of the pair of first retention elements 614 includes a first end 622 fixedly coupled to the base portion 610 and a second end 624 removably coupled to the head portion 604 of the fastening element 602. Further, each of the pair of first retention elements 614 may include a curved profile and/or a planar profile at the second end 624 thereof. In the illustrated example of FIG. 6, the second end 624 of each of the pair of first retention elements 614 includes the curved profile. Specifically, each first retention element 614 includes a first portion 626 extending orthogonally from the base portion 610, a second portion 628 extending obliquely relative to the base portion 610, and a third portion 607 extending from the second portion 628. The second portion 628 of each first retention element 614 extends at an oblique angle A1 relative to the base portion 610. The third portion 607 is embodied as a curved portion herein having the curved profile herein. The first portion 626 defines the first end 622 of the first retention element 614. The third portion 607 is bent towards the base portion 610 of the clip 608 and defines the second end 624 of the first retention element 614.

The retention system 605 further includes a pair of second retention elements 636 extending orthogonally from diametrically opposing ends 615, 617 of the base portion 610. Each of the pair of second retention elements 636 includes an L-shaped design herein. Specifically, each second retention element 636 includes a first member 625 extending orthogonally from the base portion 610. Each second retention element 636 also includes a second member 627 coupled to the first member 625 and extending orthogonally from the first member 625.

The retention system 605 further includes one or more conical spring washers 618 received within the receiving space 616 of the clip 608. The one or more conical spring washers 618 includes a number of conical spring washers 618 herein. In the illustrated example of FIG. 6, the fastener assembly 600 includes a pair of conical spring washers 618 received within the receiving space 616 of the clip 608. However, the retention system 605 may include three or more conical spring washers 618 based on application attributes. The pair of conical spring washers 618 may be arranged in a series arrangement and/or a parallel arrangement. Particularly, in the illustrated example of FIG. 6, the pair of conical spring washers 618 are arranged in the parallel arrangement.

Referring to FIG. 7, a schematic view of the pair of conical spring washers 618 arranged in the parallel arrangement is illustrated, according to an example of the present disclosure. The pair of conical spring washers 618 includes a first conical spring washer 652 and a second conical spring washer 654. The first conical spring washer 652 defines a first sidewall 656 and the second conical spring washer 654 defines a second sidewall 658. As is apparent from FIG. 7, in the parallel arrangement, the first and second conical spring washers 652, 654 are arranged such that the first sidewall 656 is in contact with the second sidewall 658.

Referring again to FIG. 6, the conical spring washers 618 are disposed between the base portion 610 of the clip 608 and the head portion 604 of the fastening element 602. Further, each of the conical spring washer 618 defines an opening (not shown) that aligns with the central opening 623 of the clip 608 to at least partially receive the shank portion 606 of the fastening element 602 therein.

The retention system 605 further includes one or more flat washers 620 received within the receiving space 616 of the clip 608. In the illustrated example of FIG. 6, the fastener assembly 600 includes a single flat washer 620. In other examples, the fastener assembly 600 may include two or more flat washers 620 based on application attributes. The flat washer 620 is disposed between the base portion 610 of the clip 608 and the pair of conical spring washers 618. The flat washer 620 defines an opening (not shown) that aligns with the central opening 623 of the clip 608 and the opening of the pair of conical spring washers 618 to at least partially receive the shank portion 606 of the fastening element 602 therein.

Further, each of the pair of first retention elements 614 applies a retention force on the head portion 604 of the fastening element 602 to retain the flat washer 620 and the pair of conical spring washers 618 between the base portion 610 of the clip 608 and the head portion 604 of the fastening element 602. Particularly, the second portion 628 and the third portion 607 of each of the first retention element 614 applies the retention force on the head portion 604 of the fastening element 602 to retain the flat washer 620 and the pair of conical spring washers 618 between the base portion 610 of the clip 608 and the head portion 604.

Furthermore, the second retention elements 636 retain the pair of conical spring washers 618 within the receiving space 616 of the clip 608. Each second retention element 636 also retains the flat washer 620 within the receiving space 616 of the clip 608. It should be noted that, during assembly, the second retention elements 636 are bent over the conical spring washer 618, thereby plastically deforming the second retention elements 636 so that they do not return to their previous position. Further, in some examples, the second retention elements 636 may not directly contact the conical spring washer 618. However, the second retention elements 636 may prevent removal of the conical spring washer 618 and the flat washer 620 from the clip 608.

In order to assemble the fastener assembly 600, the flat washer 620 and the pair of conical spring washers 618 are coupled with the clip 608, such that the flat washer 620 and the pair of conical spring washers 618 are retained within the clip 608 by each second retention element 636. Further, the shank portion 606 of the fastening element 602 is received within each of the central opening 623 of the clip 608, the opening of the flat washer 620, and the opening of the conical spring washers 618. The clip 608 is then pushed towards the head portion 604 of the fastening element 602, thereby engaging each of the pair of first retention elements 614 with the head portion 604 of the fastening element 602 via a snap arrangement.

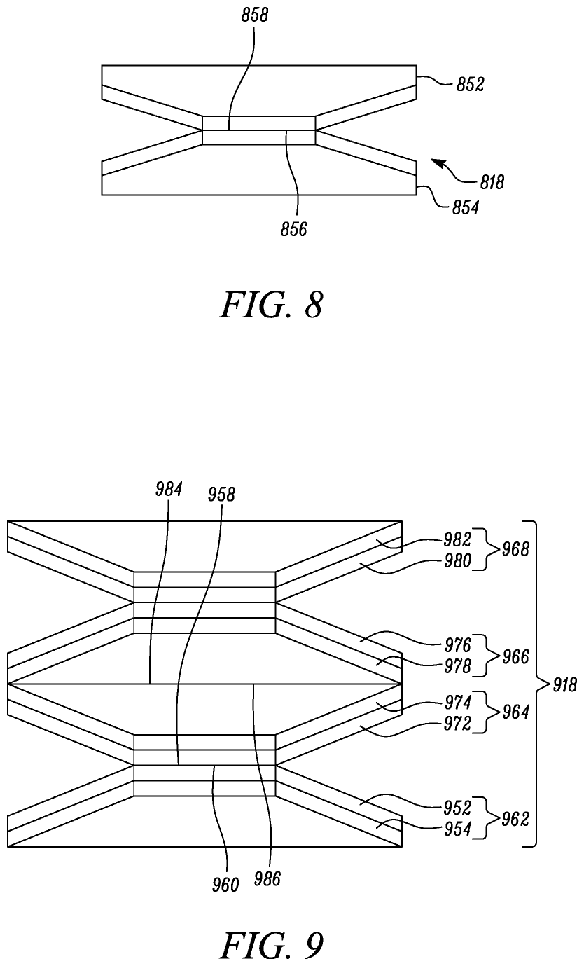

Referring to FIG. 8, a schematic side view of a pair of conical spring washers 818 arranged in the series arrangement is illustrated, according to another example of the present disclosure. Specifically, the pair of conical spring washers 818 include a first conical spring washer 852 and a second conical spring washer 854. The first conical spring washer 852 defines a top edge 856 and the second conical spring washer 854 defines a top edge 858. As is apparent from FIG. 8, in the series arrangement of the first and second conical spring washers 852, 854, the top edge 856 of the first conical spring washer 852 contacts the top edge 858 of the second conical spring washer 854. It should be noted that the pair of conical spring washers 818 may be employed in the fastener assembly 100, 200, 400, 500, 600 of FIGS. 1 to 6.

Referring to FIG. 9, a schematic side view of a number of conical spring washers 918 arranged in a series-parallel arrangement is illustrated, according to yet another example of the present disclosure. The number of conical spring washers 918 includes a first set of conical spring washers 962 arranged in a parallel arrangement. The first set of conical spring washers 962 includes a first conical spring washer 952 and a second conical spring washer 954. The parallel arrangement of the first conical spring washer 952 and the second conical spring washer 954 is same as the parallel arrangement of the first and second conical spring washers 652, 654 as explained in FIG. 7.

The number of conical spring washers 918 includes a second set of conical spring washers 964 arranged in the parallel arrangement. The second set of conical spring washer 964 includes a third conical spring washer 972 and a fourth conical spring washer 974. The parallel arrangement of the third conical spring washer 972 and the fourth conical spring washer 974 is same as the parallel arrangement of the first and second conical spring washers 652, 654 as explained in FIG. 7.

Further, the first set of conical spring washers 962 and the second set of conical spring washers 964 are arranged in a series arrangement. Specifically, a top edge 958 of the first conical spring washer 952 of the first set of conical spring washer 962 is in contact with a top edge 960 of the third conical spring washer 972 of the second set of conical spring washers 964.

Furthermore, the number of conical spring washers 918 includes a third set of conical spring washers 966 that is similar to the first set of conical spring washers 962 and a fourth set of conical spring washers 968 similar to the second set of conical spring washers 964. The third set of conical spring washers 966 includes a first conical spring washer 976 and a second conical spring washer 978. Further, the fourth set of conical spring washers 966 includes a third conical spring washer 980 and a fourth conical spring washer 982. Each of the third set of conical spring washers 966 and the fourth set of conical spring washers 968 are arranged in the series arrangement. Further, the first set of conical spring washers 962, the second set of conical spring washers 964, the third set of conical spring washers 966, and the fourth set of conical spring washers 968 are stacked on each other, such that a bottom edge 984 of the fourth conical spring washer 974 is in contact with a bottom edge 986 of the second conical spring washer 978. It should be noted that the number of conical spring washers 918 may be employed in the fastener assembly 100, 200, 400, 500, 600 of FIGS. 1 to 6.

Referring now to FIGS. 1 to 9, the conical spring washers 118, 218, 418, 518, 618, 818, 918 may be replaced by Belleville washers, or any other similar type of spring force washers, that may serve the intended purpose of the conical spring washers 118, 218, 418, 518, 618, 818, 918.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The present disclosure is related to the fastener assembly 100, 200, 400, 500, 600. Specifically, the present disclosure facilitates pre-assembly of the fastener assembly 100, 200, 400, 500, 600. The present disclosure teaches pre-assembling of the fastener assembly 100, 200, 400, 500, 600 with a controlled process, either manually or using automated means, which may reduce failures relative to assembling at the point of use, and may also reduce the time necessary to assemble the fastener assembly 100, 200, 400, 500, 600. The fastener assembly 100, 200, 400, 500, 600 includes the retention system 105, 205, 405, 505, 605. The retention system 105, 205, 405, 505, 605 includes the clip 108, 208, 408, 508, 608 removably coupled to the fastening element 102, 202, 402, 502, 602. The fastener assembly 100, 200, 400, 500, 600 also includes one or more conical spring washers 118, 218, 418, 518, 618, 818, 918 and the flat washer 120, 220, 420, 520, 620. The conical spring washers 118, 218, 418, 518, 618, 818, 918 may inhibit loosening of the fastening element 102, 202, 402, 502, 602 that may be caused due to rotation of the fastening element 102, 202, 402, 502, 602 or due to vibrations or thermal expansion.

The retention system 105, 205, 405, 505, 605 ensures correct orientation of the conical spring washers 118, 218, 418, 518, 618, 818, 918 and the flat washer 120, 220, 420, 520, 620 during assembly. Specifically, the retention system 105, 205, 405, 505, 605 ensures that all hardware components are present in the correct order and quantity in the respective fastener assembly 100, 200, 400, 500, 600. Further, the clip 108, 208, 408, 508, 608 of the retention system 105, 205, 405, 505, 605 may accommodate axial compression that is inherent in the conical spring washers 118, 218, 418, 518, 618, 818, 918.

The clip 108, 208, 408, 508, 608 defines the receiving space 116, 216, 416, 516, 616 that receives the conical spring washers 118, 218, 418, 518, 618, 818, 918. The clip 108, 208, 408, 508, 608 includes the pair of first retention elements 114, 214, 414, 514, 614 to retain the one or more conical spring washers 118, 218, 418, 518, 618, 818, 918 within the receiving space 116, 216, 416, 516, 616. Particularly, the first retention elements 114, 214, 414, 514, 614 apply the retention force on the head portion 104, 204, 404, 504, 604 of the fastening element 102, 202, 402, 502, 602 thereby retaining the one or more conical spring washers 118, 218, 418, 518, 618, 818, 918. The retention system 105, 205, 405, 505, 605 also includes the flat washer 120, 220, 420, 520, 620. The flat washer 120, 220, 420, 520, 620 may provide support to the conical spring washers 118, 218, 418, 518, 618, 818, 918 and may also provide a broader bearing surface. Further, the clip 208, 608 includes the pair of second retention elements 226, 636. The pair of second retention elements 226, 636 may allow stacking of the conical spring washers 218, 618, 818, 918 and the flat washer 220, 620. Specifically, the second retention elements 226, 636 may hold the conical spring washers 218, 618 and the flat washer 220, 620 in the clip 208, 608, without the fastening element 202, 602. This allows the retention system 205, 605 to be assembled independently of the fastening element 202, 602, and the retention system 205, 605 may be applied later. Not sure if that needs to be added here, or somewhere else.

The retention system 105, 205, 405, 505, 605 may allow installation of the conical spring washers 118, 218, 418, 518, 618, 818, 918 and the flat washer 120, 220, 420, 520, 620 in a correct order. Thus, the retention system 105, 205, 405, 505, 605 may provide an efficient and an error proof way to retain the one or more conical spring washers 118, 218, 418, 518, 618, 818, 918 and the flat washer 120, 220, 420, 520, 620 within the clip 108, 208, 408, 508, 608 of the fastener assembly 100, 200, 400, 500, 600.

Further, the retention system 105, 205, 405, 505, 605 may be assembled with the fastening element 102, 202, 402, 502, 602 after providing threads on the fastening element 102, 202, 402, 502, 602. For example, the retention system 105, 205, 405, 505, 605 described herein may be coupled with the fastening element 102, 202, 402, 502, 602 after all heat treatments and coating processes are performed on the fastening element 102, 202, 402, 502, 602, which may allow for components consisting of dissimilar materials and coatings to be used to form the fastener assembly 100, 200, 400, 500, 600.

The retention system 105, 205, 405, 505, 605 and the fastener assembly 100, 200, 400, 500, 600 may be used as a retrofit assembly on existing components/machines. Furthermore, the retention system 105, 205, 405, 505, 605 may be sold as a separate assembly, such as an aftermarket kit, that may be easily assembled with fastening elements of different designs. It should be noted that dimensions of the clip 108, 208, 408, 508, 608, the conical spring washers 118, 218, 418, 518, 618, 818, 918, and the flat washer 120, 220, 420, 520, 620 may be changed as per dimensions of the fastening elements 102, 202, 402, 502, 602.

The fastener assembly 100, 200, 400, 500, 600 described herein may allow usage the fastening element 102, 202, 402, 502, 602, the conical spring washers 118, 218, 418, 518, 618, 818, 918, and the flat washer 120, 220, 420, 520, 620 at their full strength. Therefore, as compared to a conventional fastener assembly, the fastener assembly 100, 200, 400, 500, 600 of the present disclosure may be cost-effective, and may reduce time and efforts during assembly or replacement of the fastener assembly 100, 200, 400, 500, 600.

Further, the fastener assembly 100, 200, 400, 500, 600 may exhibit improved strength over conventional fastener assemblies, as the clip 108, 208, 408, 508, 608 does not require any reduction in cross-section, a slot, or undercut in the fastening element 102, 202, 402, 502, 602 to latch onto. Further, the fastener assembly 100, 200, 400, 500, 600 may be usable to removably couple any components across a large number of product groups/industries. The fastener assembly 100, 200, 400, 500, 600 described herein allow axial movement of the fastening element 102, 202, 402, 502, 602 relative to a clamping surface, which is a requirement for conical spring washer usage. The fastener assembly 100, 200, 400, 500, 600 does not include any adhesive to hold the fastener assembly 100, 200, 400, 500, 600. Thus, the fastener assembly 100, 200, 400, 500, 600 does not create debris problems in the joint. Further, as the clip 108, 208, 408, 508, 608 is removably coupled with fastening element 102, 202, 402, 502, 602, the clip 108, 208, 408, 508, 608 may be removed and recoupled with the fastening element 102, 202, 402, 502, 602.

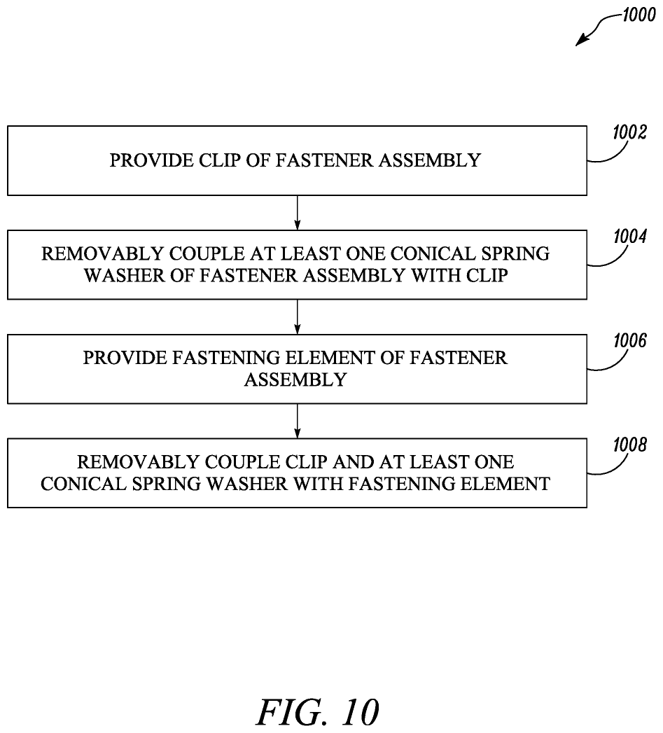

Referring to FIG. 10, a flowchart for a method 1000 of assembling the fastener assembly 100, 200, 400, 500, 600 is illustrated.

With reference to FIGS. 1 to 10, at step 1002, the clip 108, 208, 408, 508, 608 of the fastener assembly 100, 200, 400, 500, 600 is provided. The clip 108, 208, 408, 508, 608 includes the annular, base portion 110, 210, 410, 510, 610. The clip 108, 208, 408, 508, 608 also includes the pair of first retention elements 114, 214, 414, 514, 614. At least a portion of first retention elements 114, 214, 414, 514, 614 is disposed oblique to diametrically opposing ends 112, 212, 412, 512, 612, 113, 213, 413, 513, 613 of the base portion 110, 210, 410, 510, 610. The clip 108, 208, 408, 508, 608 defines the receiving space 116, 216, 416, 516, 616. The clip 208, 608 further includes the pair of second retention elements 226, 636 extending orthogonally from diametrically opposing ends 215, 217, 615, 617 of the base portion 210, 610.

At step 1004, the one or more conical spring washers 118, 218, 418, 518, 618, 818, 918 of the fastener assembly 100, 200, 400, 500, 600 are removably coupled with the clip 108, 208, 408, 508, 608. The one or more conical spring washers 118, 218, 418, 518, 618, 818, 918 are received within the receiving space 116, 216, 416, 516, 616 of the clip 108, 208, 408, 508, 608.

At step 1006, the fastening element 102, 202, 402, 502, 602 of the fastener assembly 100, 200, 400, 500, 600 is provided. The fastening element 102, 202, 402, 502, 602 includes the head portion 104, 204, 404, 504, 604 and the shank portion 106, 206, 406, 506, 606 fixedly coupled to the head portion 104, 204, 404, 504, 604.

At step 1008, the clip 108, 208, 408, 508, 608 and the one or more conical spring washers 118, 218, 418, 518, 618, 818, 918 are removably coupled with the fastening element 102, 202, 402, 502, 602. The one or more conical spring washers 118, 218, 418, 518, 618, 818, 918 are disposed between the base portion 110, 210, 410, 510, 610 of the clip 108, 208, 408, 508, 608 and the head portion 104, 204, 404, 504, 604 of the fastening element 102, 202, 402, 502, 602.

In some examples, the step of removably coupling the one or more conical spring washers 218, 618, with the clip 208, 608 further includes retaining the one or more conical spring washers 218, 618 within the receiving space 216, 616 of the clip 208, 608 by the pair of second retention elements 226, 636.

In some examples, the step of removably coupling the clip 108, 208, 408, 508, 608 and the one or more conical spring washers 118, 218, 418, 518, 618, 818, 918 with the fastening element 102, 202, 402, 502, 602 further includes receiving, at least partially, the shank portion 106, 206, 406, 506, 606 of the fastening element 102, 202, 402, 502, 602 within the central opening 123, 223, 423, 523, 623 of the base portion 110, 210, 410, 510, 610. In some examples, the step of removably coupling the clip 108, 208, 408, 508, 608 and the one or more conical spring washers 118, 218, 418, 518, 618, 818, 918 with the fastening element 102, 202, 402, 502, 602 further includes engaging each of the pair of first retention elements 114, 214, 414, 514, 614 of the clip 108, 208, 408, 508, 608 with the head portion 104, 204, 404, 504, 604 of the fastening element 102, 202, 402, 502, 602.

In some examples, the step of removably coupling the clip 108, 208, 408, 608 and the one or more conical spring washers 118, 218, 418, 618, 818, 918 with the fastening element 102, 202, 402, 602 further includes engaging each of the pair of first retention elements 114, 214, 414, 614 with the head portion 104, 204, 404, 604 of the fastening element 102, 202, 402, 602 by a snap arrangement.

In some examples, the step of removably coupling the clip 508 and the one or more conical spring washers 518 with the fastening element 502 further includes applying a bending force on each of the pair of first retention elements 514 of the clip 508 until each of the pair of first retention elements 514 of the clip 508 engages with the head portion 504 of the fastening element 502.

In some examples, the method 1000 further includes a step of removably coupling one or more flat washers 120, 220, 420, 520, 620 of the fastener assembly 100, 200, 400, 500, 600 with the clip 108, 208, 408, 508, 608. The one or more flat washers 120, 220, 420, 520, 620 are received within the receiving space 116, 216, 416, 516, 616 of the clip 108, 208, 408, 508, 608. The one or more flat washers 120, 220, 420, 520, 620 are disposed between the base portion 110, 210, 410, 510, 610 of the clip 108, 208, 408, 508, 608 and the one or more conical spring washers 118, 218, 418, 518, 618, 818, 918.

In some examples, the method 1000 further includes a step of applying, by each of the pair of first retention elements 114, 214, 414, 514, 614 of the clip 108, 208, 408, 508, 608, the retention force on the head portion 104, 204, 404, 504, 604 of the fastening element 102, 202, 402, 502, 602. The method 1000 further includes a step of retaining the one or more flat washers 120, 220, 420, 520, 620 and the one or more conical spring washers 118, 218, 418, 518, 618, 818, 918 between the base portion 110, 210, 410, 510, 610 of the clip 108, 208, 408, 508, 608 and the head portion 104, 204, 404, 504, 604 of the fastening element 102, 202, 402, 502, 602, based on the retention force applied by each of the pair of first retention elements 114, 214, 414, 514, 614 of the clip 108, 208, 408, 508, 608.

In some examples, the one or more conical spring washers 618, 818, 918 includes the number of conical spring washers 618, 818, 918. In some examples, the step of removably coupling the one or more conical spring washers 618, 818 with the clip 108, 208, 408, 508, 608 also includes arranging the number of conical spring washers 618, 818 in a series arrangement and/or a parallel arrangement. Particularly, the conical spring washers 618 are arranged in the parallel arrangement and the conical spring washers 818 are arranged in the series arrangement.

In some examples, the number of conical spring washers 918 includes the first set of conical spring washers 962 and the second set of conical spring washers 964. Further, in some examples, the step of removably coupling the one or more conical spring washers 918 with the clip 108, 208, 408, 508, 608 includes arranging the first set of conical spring washers 962 in the parallel arrangement. In some examples, the step of removably coupling the at least one conical spring washer 918 with the clip 108, 208, 408, 508, 608 further includes arranging the second set of conical spring washers 964 in the parallel arrangement. In some examples, the step of removably coupling the at least one conical spring washer 918 with the clip 108, 208, 408, 508, 608 further includes arranging the first set of conical spring washers 962 and the second set of conical spring washers 964 in the series arrangement.

While aspects of the present disclosure have been particularly shown and described with reference to the embodiments above, it will be understood by those skilled in the art that various additional embodiments may be contemplated by the modification of the disclosed work machine, systems and methods without departing from the spirit and scope of the disclosure. Such embodiments should be understood to fall within the scope of the present disclosure as determined based upon the claims and any equivalents thereof.

What is claimed is:

1. A fastener assembly comprising:
a fastening element including a head portion and a shank portion fixedly coupled to the head portion; and
a retention system coupled to the fastening element, the retention system including:
a clip removably coupled to the fastening element, wherein the clip includes:
an annular, base portion; and
a pair of first retention elements, at least a portion of the first retention elements is disposed oblique to diametrically opposing ends of the base portion, wherein the clip defines a receiving space; and
at least one conical spring washer received within the receiving space of the clip, wherein the at least one conical spring washer is disposed between the base portion of the clip and the head portion of the fastening element.

2. The fastener assembly of claim 1, wherein the base portion defines a central opening of the base portion, wherein the central opening at least partially receives the shank portion of the fastening element, and wherein each of the pair of first retention elements of the clip engages with the head portion of the fastening element.

3. The fastener assembly of claim 1, wherein the clip further includes a pair of second retention elements extending orthogonally from diametrically opposing ends of the base portion, and wherein each of the pair of second retention elements of the clip retains the at least one conical spring washer within the receiving space of the clip.

4. The fastener assembly of claim 1, wherein the retention system further includes at least one flat washer received within the receiving space of the clip, and wherein the at least one flat washer is disposed between the base portion of the clip and the at least one conical spring washer.

5. The fastener assembly of claim 4, wherein each of the pair of first retention elements applies a retention force on the head portion of the fastening element to retain the at least one flat washer and the at least one conical spring washer between the base portion of the clip and the head portion of the fastening element.

6. The fastener assembly of claim 1, wherein each of the pair of first retention elements includes a first end fixedly coupled to the base portion and a second end removably coupled to the head portion of the fastening element.

7. The fastener assembly of claim 6, wherein each of the pair of first retention elements includes at least one of a curved profile and a planar profile at the second end thereof.

8. The fastener assembly of claim 1, wherein the at least one conical spring washer includes a plurality of conical spring washers.

9. The fastener assembly of claim 8, wherein the plurality of conical spring washers are arranged in at least one of a series arrangement and a parallel arrangement.

10. The fastener assembly of claim 8, wherein the plurality of conical spring washers include a first set of conical spring washers arranged in a parallel arrangement and a second set of conical spring washers arranged in a parallel arrangement, and wherein the first set of conical spring washers and the second set of conical spring washers are arranged in a series arrangement.

11. A method of assembling a fastener assembly, the method comprising:
providing a clip of the fastener assembly, the clip including an annular, base portion and a pair of first retention elements, at least a portion of the first retention elements is disposed oblique to diametrically opposing ends of the base portion, wherein the clip defines a receiving space;
removably coupling at least one conical spring washer of the fastener assembly with the clip, wherein the at least one conical spring washer is received within the receiving space of the clip;
providing a fastening element of the fastener assembly, the fastening element including a head portion and a shank portion fixedly coupled to the head portion; and
removably coupling the clip and the at least one conical spring washer with the fastening element, wherein the at least one conical spring washer is disposed between the base portion of the clip and the head portion of the fastening element.

12. The method of claim 11, wherein the step of removably coupling the clip and the at least one conical spring washer with the fastening element further includes:
receiving, at least partially, the shank portion of the fastening element within a central opening of the base portion; and
engaging each of the pair of first retention elements of the clip with the head portion of the fastening element.

13. The method of claim 11, wherein the clip further includes a pair of second retention elements extending orthogonally from diametrically opposing ends of the base portion, and wherein the step of removably coupling the at least one conical spring washer with the clip further includes retaining, by the pair of second retention elements of the clip, the at least one conical spring washer within the receiving space of the clip.

14. The method of claim 11, further comprising removably coupling at least one flat washer of the fastener assembly with the clip, wherein the at least one flat washer is received within the receiving space of the clip, and wherein the at least one flat washer is disposed between the base portion of the clip and the at least one conical spring washer.

15. The method of claim 14, further comprising:
applying, by each of the pair of first retention elements of the clip, a retention force on the head portion of the fastening element; and
retaining the at least one flat washer and the at least one conical spring washer between the base portion of the clip and the head portion of the fastening element, based on the retention force applied by each of the pair of first retention elements of the clip.

16. The method of claim 11, wherein the step of removably coupling the clip and the at least one conical spring washer with the fastening element further includes engaging each of the pair of first retention elements with the head portion of the fastening element by a snap arrangement.

17. The method of claim 11, wherein the step of removably coupling the clip and the at least one conical spring washer with the fastening element further includes applying a bending force on each of the pair of first retention elements of the clip until each of the pair of first retention elements of the clip engages with the head portion of the fastening element.

18. The method of claim 11, wherein the at least one conical spring washer includes a plurality of conical spring washers.

19. The method of claim 18, wherein the step of removably coupling the at least one conical spring washer with the clip further includes arranging the plurality of conical spring washers in at least one of a series arrangement and a parallel arrangement.

20. The method of claim 18, wherein the plurality of conical spring washers include a first set of conical spring washers and a second set of conical spring washers, and wherein the step of removably coupling the at least one conical spring washer with the clip further includes:
arranging the first set of conical spring washers in a parallel arrangement;
arranging the second set of conical spring washers arranged in a parallel arrangement; and
arranging the first set of conical spring washers and the second set of conical spring washers in a series arrangement.
